(19) United States
(12) Patent Application Publication
(10) Pub. No.: US 2025/0232192 A1
(43) Pub. Date: Jul. 17, 2025

(54) DIVERSE ANOMALOUS SUBSET DISCOVERY VIA PENALIZED INTERSECTION

(71) Applicant: International Business Machines Corporation, Armonk, NY (US)

(72) Inventors: JOHN WAMBURU, GATUKUYU (KE); Adebayo Ayomide Oshingbesan, Ota (NG); Celia Cintas, Nairobi (KE); Skyler SPEAKMAN, NAIROBI (KE)

(21) Appl. No.: 18/413,458

(22) Filed: Jan. 16, 2024

(51) Int. Cl. G06N 5/022

(52) U.S. Cl. CPC G06N 5/022

(57) ABSTRACT

One or more systems, devices, computer program products and/or computer-implemented methods of use provided herein relate to automated control for a physical system with generic forecasting models. The computer-implemented system can comprise a memory that can store computer executable components. The computer-implemented system can further comprise a processor that can execute the computer executable components stored in the memory, wherein the computer executable components can comprise a discovery component that obtains a candidate anomalous subset of a dataset, a scoring component that computes a diversity score of the candidate anomalous subset relative to selected subsets of the dataset, and a selection component that selects the candidate anomalous subset based on the diversity score. Furthermore, the level of diversity between subsets can be controlled by a user. Moreover, records can be penalized to enable search space exploration and mitigate redundancy at the record level.

### BACKGROUND

The subject disclosure relates to anomalous subset discovery and, more specifically, to diverse anomalous subset discovery via penalized intersection.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable automated control for a physical system with generic forecasting models.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a discovery component that obtains a candidate anomalous subset of a dataset; a scoring component that computes a diversity score of the candidate anomalous subset relative to selected subsets of the dataset; and a selection component that selects the candidate anomalous subset based on the diversity score.

According to another embodiment, a computer-implemented method is provided. The computer-implemented method can comprise obtaining, by a system operatively coupled to a processor, a candidate anomalous subset of a dataset; computing, by the system, a diversity score of the candidate anomalous subset relative to selected subsets of the dataset; and selecting, by the system, the candidate anomalous subset based on the diversity score.

According to yet another embodiment, a computer program product for facilitating automated control for a physical system with generic forecasting models is provided. The computer program product can comprise a computer readable storage medium having program instructions embodied therewith, the program instructions executable by a processor to cause the processor to obtain a candidate anomalous subset of a dataset; compute a diversity score of the candidate anomalous subset relative to selected subsets of the dataset; and select the candidate anomalous subset based on the diversity score.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate diverse anomalous subset discovery via penalized intersection in accordance with one or more embodiments described herein.

FIG. 2 illustrates a block diagram of an example, non-limiting system that can facilitate diverse anomalous subset discovery via penalized intersection in accordance with one or more embodiments described herein.

FIG. 3 illustrates an example, non-limiting representation of overlapping records between a candidate subset and previously selected subsets in accordance with one or more embodiments described herein.

FIG. 4 illustrates an example, non-limiting representation of diverse anomalous subset discovery via penalized intersection in accordance with one or more embodiments described herein.

FIG. 5 illustrates an example, non-limiting representation of interval evaluation of record penalties in accordance with one or more embodiments described herein.

FIG. 6 illustrates an example, non-limiting algorithm to facilitate diverse anomalous subset discovery via penalized intersection in accordance with one or more embodiments described herein.

FIG. 7 illustrates an example, non-limiting evaluation of approximating diverse anomalous subset discovery via penalized intersection in accordance with one or more embodiments described herein.

FIG. 8 illustrates an example, non-limiting evaluation of approximating diverse anomalous subset discovery via penalized intersection in accordance with one or more embodiments described herein.

FIG. 9 illustrates a flow diagram of an example, non-limiting method of facilitating diverse anomalous subset discovery via penalized intersection in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Discovery of anomalous patterns or rules in data is important for analysis of bias or fairness of machine learning models. For example, business applications of subset discovery can include credit scoring, artificial intelligence (AI) fairness, or drift detection in data. Anomalous patterns in data can be any patterns that deviate from normal or expected behavior. More specifically, the anomalousness of a subset can represent the over-representation or under-representation of the outcome compared to the expectation, and can be measured by a scoring function.

Top-k subset discovery can comprise obtaining a list of k subsets that contain the most anomalous subsets of a dataset. Obtaining top-k subsets can be applied to, for example, identify which subgroups an AI model is frequently mistaking to resolve such issues in the AI model. Furthermore, it can be applied to multiple domains such as monitoring events (e.g., disease outbreaks, disasters, fraud) by identifying data patterns indicating a rate of occurrence that is higher than the expected rate. Diversity in a set of top-k subsets can be measured by the proportion of intersecting records covered by each subset. Subsets that maximize divergence from the expectation while minimizing redundancy in the records covered by each subset can be desirable for subset discovery.

However, current methods of subset discovery face various challenges.

First, handling of large search spaces in high-dimensional datasets can be challenging for current methods of anomalous subset discovery, as the number of potential subsets grows exponentially with the number of features in the dataset. the search space of a dataset for anomalous subset discovery comprises all possible combinations of unique values of dataset feature, from which are searched to uncover the top-k anomalous subsets. For example, if a tabular dataset comprises one column representative of a feature, and wherein the feature had n unique values, the search space of the dataset can be up to O(2ⁿ−1) combinations if the null is not considered. The size of the search space can pose computational challenges, impacting efficiency and scalability of such methods, because it can be computationally infeasible to perform an exhaustive search. In relatively lower-dimensional datasets, subset discovery can still become intractable, even if equipped with supercomputers to use brute force to search all possible and different combinations of subsets. For example, the search space of a feature comprising x unique values contain 2^{x}−1 different combinations of values that must be considered to perform an exhaustive search. Furthermore, in top-k subset discovery, obtaining multiple anomalous subsets can become even more challenging, wherein each following subset is more difficult to obtain than the previous. For example, if the case k=6, obtaining the second, third, fourth, and fifth most anomalous subset is more challenging than obtaining the first most anomalous subset. Current methods address such an issue by reducing the search space to obtain the top-k subsets. In other words, conventional methods comprise various techniques to prune the search space to reduce the number of combinations that will be searched and consider one element across each column. Elements are then joined using the logical AND operator to form a subset description. However, pruning results in a trade-off of the anomalousness of discovered subsets with a gain in run-time. Furthermore, complexity of subsets that can be described reduces because the search space is reduced.

Second, search space reduction can lead to redundancy of subsets on the record level. More specifically, the obtained subsets comprise the same records or records that slight variations of other records in the obtained subsets. For example, a dataset can contain the following features:

| | |
|---|---|
| age | positive integer |
| gender | {male, female} |
| relationship | {husband, wife, unmarried} |
| education | {bachelors, masters, doctorate} |

A method that reduces search space size or experiences redundancy at the record level can return, for example, the following anomalous subsets:

$$gender = female ∧ education = doctorate$$

$$relationship = wife ∧ education = doctorate$$

$$education = doctorate ∧ gender \neq male$$

The three subsets, although with varying descriptions, describe the same or a similar subject (e.g., highly educated females). Therefore, diverse subset discovery is not achieved as all or most subsets describe the same group and contain overlap. Subset redundancy can be caused by, for example, high cardinality in feature values, latent dependencies, or correlation among features. Furthermore, methods can perform redundancy pruning in post-processing. However, post-processing redundancy mitigation can lead to suboptimal top-k subsets. Moreover, many methods and techniques for subset discovery are concerned with diversity at the subset description level (e.g., groups, subsets, or combinations of records of data that exhibit anomalous behavior), rather than at the record level (e.g., individual data points or records for detection of anomalies).

Third, current methods of subset discovery are not capable of searching larger search spaces. In other words, reducing a search space also prevents search space exploration. Conventional methods therefore operate on a limited search space, which can further contribute to redundancy on the record level.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate diverse anomalous subset discovery via penalized intersection. That is, various disadvantages associated with existing techniques for subset discovery can be ameliorated by diverse anomalous subset discovery via penalized intersection.

In various embodiments, an initialization component can initialize a dataset with a penalty value of zero for each record. In various aspects, a discovery component can obtain a candidate anomalous subset by determining records in the candidate anomalous subset that overlap with a set of selected anomalous subsets. Thus, a selection component can select the candidate anomalous subset based on a determination that the diversity score does not exceed a diversity threshold. Furthermore, the diversity threshold can be controlled or changed based on a desired level of diversity by a user. Moreover, a regularization component can penalize overlapping records of the candidate anomalous subset by a regularization parameter in response to a determination that the diversity score exceeds the diversity threshold. Therefore, search space exploration can be enabled for the discovery component because redundant records comprise larger penalty values. Moreover, the regularization component iteratively penalizes overlapping records of candidate anomalous subsets until a subset is obtained that comprises a suitable level of diversity. Thus, diversity and redundancy mitigation among the selected subsets can be guaranteed, along with larger exploration of the underlying search space.

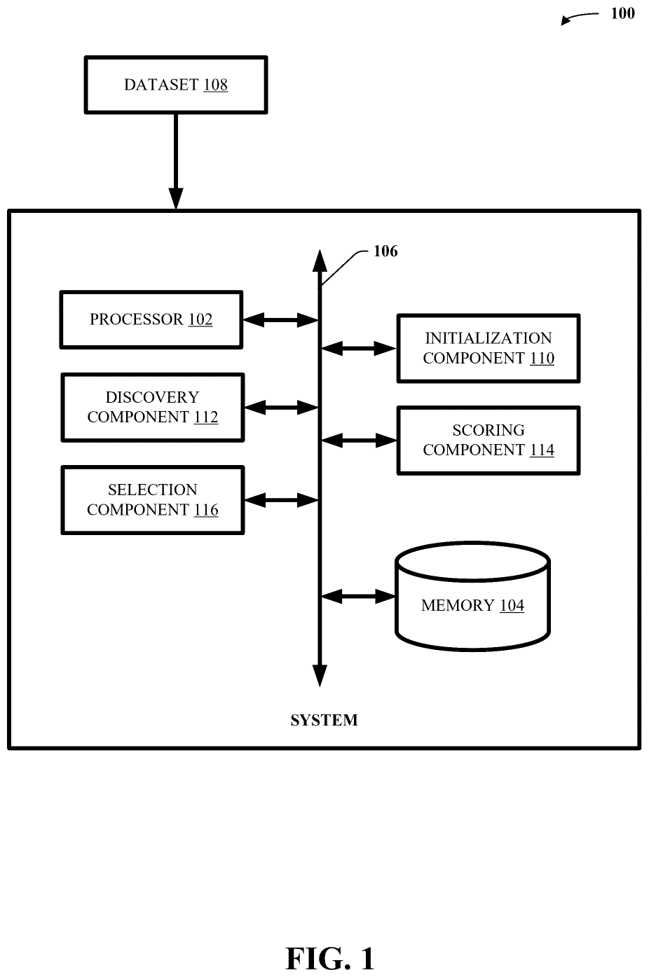

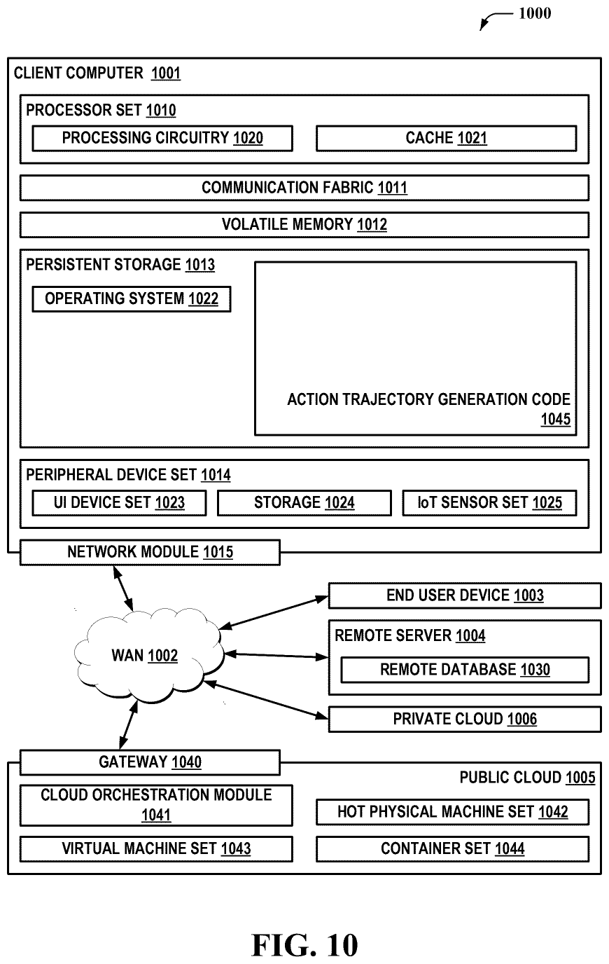

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated in FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate diverse anomalous subset discovery via penalized intersection in accordance with one or more embodiments described herein. System 100 can comprise processor 102, memory 104, system bus 106, and initialization component 110, discovery component 112, scoring component 114, and selection component 116.

The system 100 and/or the components of the system 100 can be employed to use hardware and/or software to solve problems that are highly technical in nature (e.g., record overlap computing, subset discovery, subset intersection penalization etc.), that are not abstract and that cannot be performed as a set of mental acts by a human. Further, some of the processes performed may be performed by specialized computers for carrying out defined tasks related to diverse anomalous subset discovery via penalized intersection. The system 100 and/or components of the system can be employed to solve new problems that arise through advancements in technology, computer networks, the Internet and the like. The system 100 can provide technical improvements to diverse anomalous subset discovery.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., initialization component 110, discovery component 112, scoring component 114, and/or selection component 116) to perform one or more actions. In one or more embodiments, memory 104 can store computer-executable components (e.g., initialization component 110, discovery component 112, scoring component 114, and/or selection component 116).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the discovery component 112 can obtain a candidate anomalous subset. Then, the scoring component 114 can determine the proportion of overlapping records between the candidate anomalous subset and previously selected subsets to compute a diversity score. Additional aspects of the one or more embodiments discussed herein are explained in greater detail with reference to subsequent figures. System 100 can be associated with, such as accessible via, a computing environment 1000 described below with reference to FIG. 10. For example, system 100 can be associated with a computing environment 1000 such that aspects of processing can be distributed between system 100 and the computing environment 1000.

In various embodiments, the initialization component 110 can initialize a dataset 108. In various aspects, the dataset 108 can be a tabular dataset (i.e., a structured collection of data organized in rows and columns, where each row represents a particular record and each column represents a particular attribute or variable). As an example, dataset 108 can be defined by D={r₁, r₂, . . . , rₙ}, where rᵢ denotes a particular record of dataset 108 and n defines the number of records in dataset 108. In various aspects, the initialization component 110 can initialize dataset 108 as an array R of size n, wherein each index i in R maps to a corresponding record rᵢ in dataset 108. Array R contains a penalty value for each record rᵢ in dataset 108. In various instances, the initialization component 110 can initialize the penalty values of each record in array R to zero (i.e., R[i]=0 ∀i∈[1,n]).

In various embodiments, the discovery component 112 can employ a Multi-dimensional Subset Scan (MD-Scan) to obtain a most anomalous subset of dataset 108. More specifically, the discovery component 112 can utilize a randomized iterative ascent procedure of MD-Scan to discover the most anomalous subset. MD-Scan can discover the most anomalous subset of a dataset by operating on a larger search space and the Additive Linear Time Subset Scanning property (ALTSS) (i.e., enables maximization of scoring functions over a single feature by only considering linearly many subsets of its feature values). Thus, search space can be reduced because only linearly many subgroups do not need to be evaluated, and disjunctions can be included between feature values (e.g., logical ORs). The discovery component 112 can extend MD-Scan to the top-k case by utilizing the ATLSS property by setting penalties on intersecting records such that the score of subsets that cover such records is reduced while opting for records not previously seen.

In various embodiments, the scoring component 114 can compute a diversity score (e.g., quantitative diversity metric) of a subset discovered through MD-Scan relative to subsets that have previously been selected (e.g., top-k subsets). Thus, the selection component 116 can select the candidate subset (e.g., discovered subset) to be added to the top-k subsets based on the computed diversity score. The scoring component 114 can compute the diversity score d of a candidate subset using Equation 1.

$$d = \frac{\vert {S}_{c} ⋂ {S}_{p} \vert}{\vert {S}_{c} \vert} \qquad Equation 1$$

where S_{c} denotes the candidate subset and S_{P} denotes the union of all previously selected subsets (i.e., S_{P}=∪{S₁, S₂, S₃, . . . , Sₖ}).

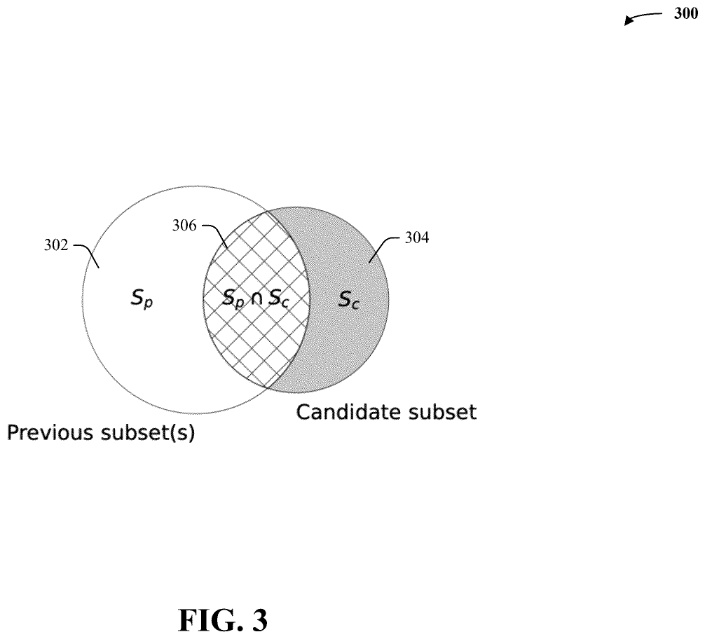

Equation 1 measures the proportion of records contained in the candidate subset S_{c} that are not contained in previously selected subsets S_{P} (e.g., records that do not overlap between the candidate subset and previously selected subsets). An overlapping record can be a record rᵢ such that the candidate subset and previously selected subsets both contain the record rᵢ (e.g., rᵢ ∈S_{c} and rᵢ ∈Sₚ). The overlapping (e.g., redundancy) of records between the candidate subset S_{c} and previously selected subsets S_{P} can be visualized by FIG. 3. Previous subsets 302 and candidate subset 304 can contain overlapping records 306. The overlapping records 306 can be defined as the intersection of previous subsets 302 and candidate subset 304 (e.g., S_{P} ∩S_{c}). In various aspects, measuring of the diversity score d can enable search space exploration. More specifically, as the proportion of records in S_{c} that do not overlap increases, the further exploration of the underlying search space there is. Furthermore, the diversity score d can also be computed using other implicit metrics. For example, Jaccard similarity index (i.e., a measure of similarity between two subsets, defined as the proportion of size of intersection to the size of the union of the subsets) can be utilized to measure diversity of candidate subsets. In the case of a large k, Equation 1 can be more desirable to measure diversity.

In various embodiments, the selection component 116 can determine if the candidate subset S_{c} is added to the set of top-k subsets based on the diversity score d of the candidate subset S_{c}. The selection component 116 can compare the diversity score d to a penalty threshold (e.g., diversity threshold) ρ. More specifically, if d<ρ, the selection component 116 can add S_{c} to the top-k subsets because the diversity score does not exceed the diversity threshold. Conversely, if d>ρ, the selection component 116 can reject S_{c} because the diversity score exceeds the diversity threshold. In other words, the number of records in the candidate subset S_{c} that overlap with records in the previously selected subsets Sₚ exceed the diversity threshold. Furthermore, the penalty threshold ρ can be defined by a user and controlled according to the user's desired level of subset diversity. For example, if a lower level of diversity among anomalous subsets is desired or acceptable to a user, the user can set ρ=0.5, meaning that candidate subsets can overlap with previously selected subsets up to 50%. Conversely, if higher subset diversity is desired, the user can set ρ=0.2, meaning that candidate subsets can overlap with previously selected subsets up to 20%.

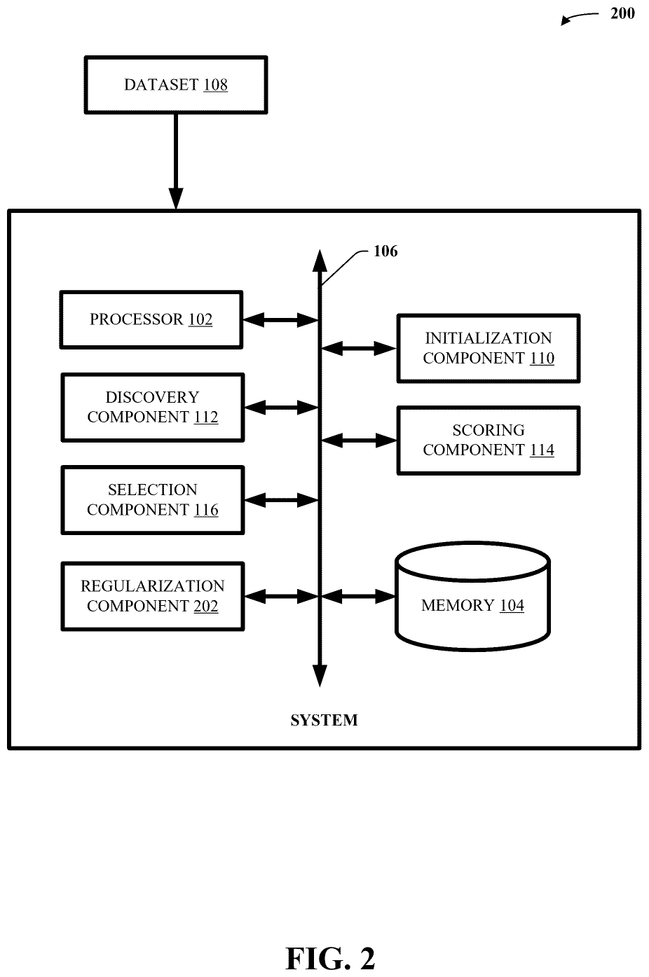

FIG. 2 illustrates a block diagram of an example, non-limiting system 200 that can facilitate diverse anomalous subset discovery via penalized intersection in accordance with one or more embodiments described herein. As shown, the system 200 can, in some cases, comprise the same components as the system 100, and can further comprise a regularization 202.

In various embodiments, the regularization component 202 can increment the penalty values of records that overlap between the candidate anomalous subset and the selected subsets by a regularization parameter δ in response to a determination that the candidate anomalous subset S_{c} is not selected. That is, if the number of records of the candidate subset S_{c} that overlap with previously selected subsets exceeds the diversity threshold ρ, the regularization component 202 can penalize the overlapping records of the candidate subset S_{c} by adding the regularization parameter δ to the penalty values in array R of the corresponding overlapping records. Therefore, larger search space exploration is enabled for the discovery component 112 by encouraging exploration of records with smaller penalty values, and thus redundancy among discovered subsets can be minimized.

As an example, a user can provide a dataset or a set of records from which anomalous subsets will be discovered (e.g., dataset 108). Furthermore, the records are in tabular form (e.g., records containing customer information and their credit scores).

The system 200 can take as additional inputs, a regularization parameter that specifies a penalization value for intersecting records (e.g., δ), and a threshold parameter that defines an amount of allowable (e.g., desired) overlap between records (e.g., ρ), and the desired number of subsets k. For example, a user can provide input on such parameters to be δ=0.15 and ρ=0.3 for k=4 subsets.

Following, the discovery component 112 can run subset scanning on the dataset, and obtain the most anomalous subset. Further, the discovery component 112 can iteratively perform subset scanning, wherein the regularization component 202 penalizes repeated records at each iteration, until the number of subsets k is selected. More specifically, the regularization component 202 can iteratively add the regularization parameter δ=0.15 to penalty values corresponding to the repeated records. Subset scanning can be iteratively performed until an obtained subset comprises a diversity score d, computed by the scoring component 114, that does not exceed the threshold parameter ρ=0.3. The selection component 116 can add the obtained subset to the top-k subsets (e.g., selected subsets) if the diversity score does not exceed the threshold parameter (e.g., d<0.3). After k=4 subsets are selected by the selection component 116, the top-k most anomalous subsets are returned to the user. Furthermore, these subsets are guaranteed to not overlap by more than the threshold parameter (e.g., 30%)

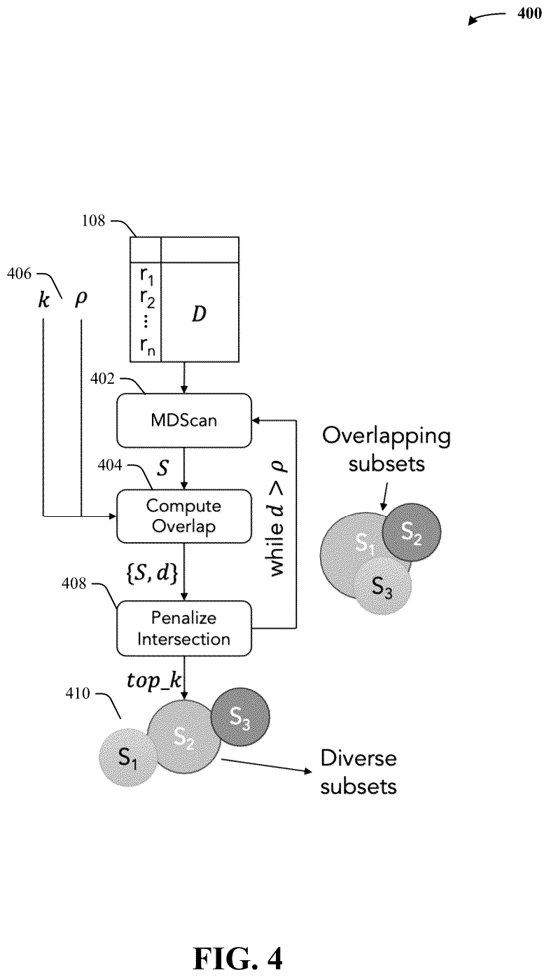

FIG. 4 illustrates an example, non-limiting representation of diverse anomalous subset discovery via penalized intersection in accordance with one or more embodiments described herein.

Depicted by 400 is an overview of diverse anomalous subset discovery via penalized intersection. The dataset 108 can be denoted by D and contain records r₁, r₂, . . . , rₙ, where n defines the length of dataset D. The discovery component 112 can perform an MD-Scan 402 on dataset D to obtain a candidate anomalous subset S. Following discovery of candidate subset S, the scoring component 114 can compute overlap 404 of candidate anomalous subset S and previously selected subsets. Computation of overlap can receive parameters 406, wherein parameters 406 comprise desired number of top anomalous subsets k and diversity threshold ρ, and output the candidate subset S and a corresponding diversity score d. Then the regularization component can perform a penalization 408 on all the records that are intersecting. Following, if d>ρ (e.g., intersection of records exceeds the determined diversity threshold), the discovery component 112 can perform another iteration of MD-Scan 402. In various embodiments, MD-Scan 402, overlap computation 404, and penalization 408 can be performed iteratively until a diverse anomalous subset is discovered (e.g., a subset such that intersecting records does not exceed the determined diversity threshold). When a diverse anomalous subset is obtained, the selection component 116 can add the candidate subset S to the set of top-k subsets 410. Furthermore, diverse anomalous subset discovery can be performed until k anomalous subsets are obtained.

Moreover, the first anomalous subset S₁ discovered can be added to the top-k subsets without computation of a diversity score because it is the first discovered subset. Therefore, there are no other selected subsets to determine overlapping records between. After the first subset S₁ is selected, the discovery component 112 can obtain the next most anomalous subset (e.g., a candidate anomalous subset) S_{c} of dataset 108. Thus, the scoring component 114 can measure diversity between S₁ and the candidate subset S_{c}. In other words, the scoring component 114 can determine records in S_{c} that overlap with records in S₁ (e.g., determine records in S_{c} that are also in S₁).

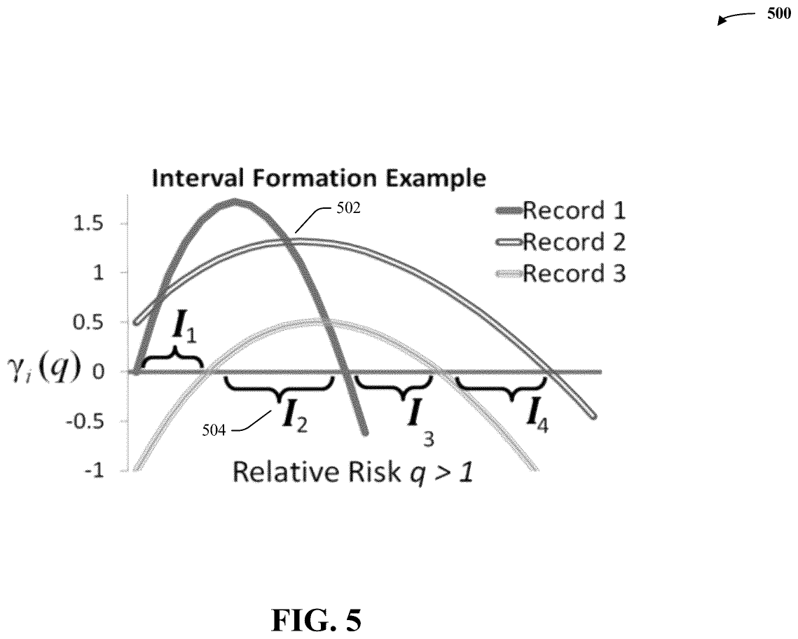

FIG. 5 illustrates an example, non-limiting representation of interval evaluation of record penalties in accordance with one or more embodiments described herein.

The penalty values of records in dataset 108 are evaluated on curves, rather than a linear space, as depicted by graph 500. More specifically, determination of penalty values operate on a combination of y-maxes, left intercepts, and right intercepts. Curves 502 of record 1, record 2, and record 3 can determine the extent to which the records deviate from expectations over intervals 504. Anomalous records can be determined by moving curves 502 up and down along the y-axis. The penalty values obtained of record 1, record 2, and record 3 are responsible for moving curves 502 up and down until a suitable combination of records that is diverse and anomalous is obtained.

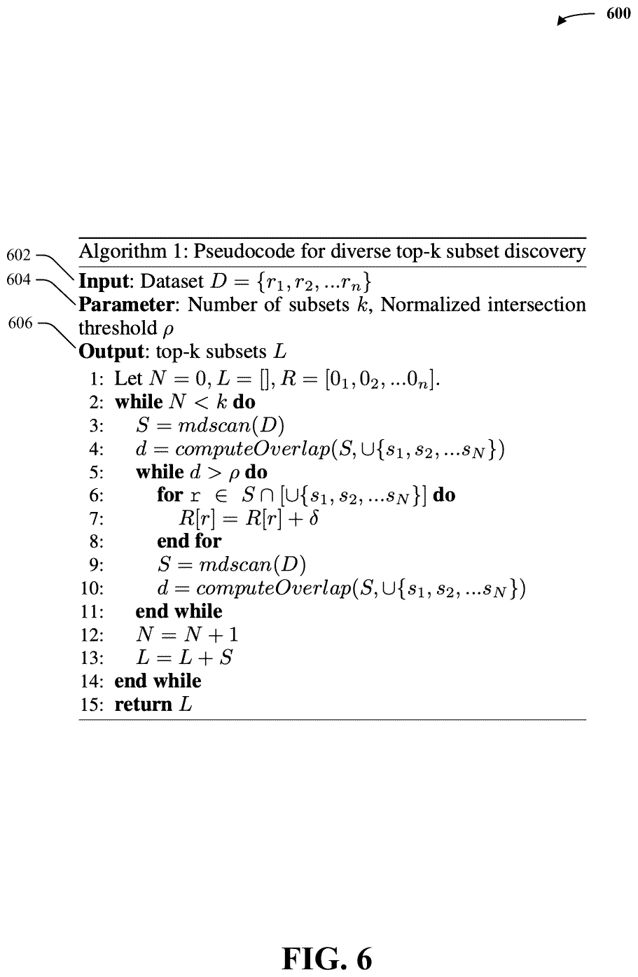

FIG. 6 illustrates an example, non-limiting algorithm to facilitate diverse anomalous subset discovery via penalized intersection in accordance with one or more embodiments described herein.

The methods described herein can be implemented using algorithm 600. More specifically, algorithm 600 can receive input 602 of a dataset D={r₁, r₂, . . . , rₙ}(e.g., dataset 108) and comprise parameters 604, containing k (e.g., number of desired subsets) and ρ (e.g., normalized intersection threshold, diversity threshold). Utilizing the algorithm as shown with input 602 and parameters 604, algorithm 600 can return output 606, a set of the top-k subsets, denoted by L.

In various embodiments, the initialization component 110 can initialize an array R=[0₁, 0₂, . . . , 0ₙ] that sets penalty values of each record rᵢ to 0. Furthermore, N represents the current number of selected subsets. While less than k subsets have been selected (e.g., while N<k), the discovery component 112 can obtain a candidate anomalous subset S and the scoring component 114 can compute the overlap of records between the union of all previously selected subsets (e.g., diversity score d). Thus, if d<ρ, N can be incremented and S can be added to the set of the top-k subsets L. Conversely, if d>ρ, the regularization component 202 can penalize the overlapping records for each record r∈S∩[∪{s₁, s₂, . . . , s_{N}}] by adding a regularization parameter δ to each corresponding penalty value in array R (e.g., R[r]). Penalization can be iteratively performed until the discovery component 112 obtains a subset that does not exceed the diversity threshold. After k subsets have been selected as the top-k subsets, the algorithm 600 can return L, the top-k subsets.

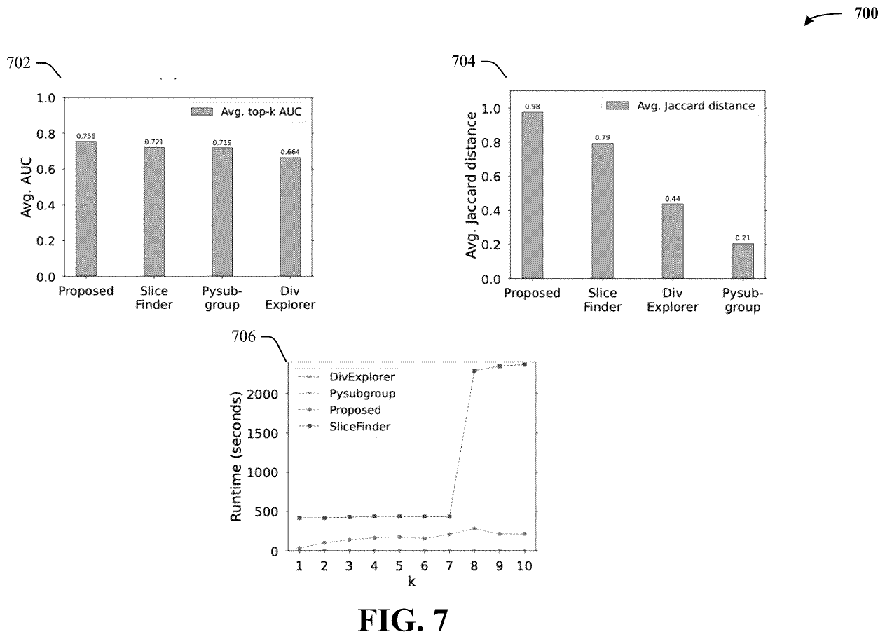

FIG. 7 illustrates an example, non-limiting evaluation of approximating diverse anomalous subset discovery via penalized intersection in accordance with one or more embodiments described herein.

Depicted in bar graph 702 is the area under the curve (AUC) of the proposed method and other methods of subset discovery, wherein the y-axis represents the average AUC. As show, the average AUC of the proposed method is 0.755, exhibiting a higher AUC than the other methods of subset discovery, and therefore indicating enhanced performance.

Depicted in bar graph 704 is record level diversity across three datasets between the proposed method and the other methods of subset discovery. Record level diversity can be evaluated by computing the Jaccard distance between each subset of the top-k subsets and the union of all prior subsets. In other words, for each subset Sₖ, the proportion of records introduced by Sₖ into the top-k sequence that do not overlap with all previous records in the top-k subsets are measured. A higher Jaccard distance indicates lower redundancy between Sₖ and previous records. As shown, the proposed method exhibits a significantly higher average Jaccard distance than the other subset discovery methods, indicating significant improvement in subset diversity on the record level. For example, the proposed method in bar graph 704 experiences an average Jaccard distance of 0.98.

Depicted in graph 706 is the run-time of the proposed method against the other methods of subset discovery. More specifically, the run-time to generate the top-k subsets of such methods is depicted in graph 706 as k increases (e.g., the number of top-k subsets increases). The y-axis of graph 706 represents the run-time in seconds and the x-axis of graph 706 represents k. The proposed method is able to exhibit a run-time that increases linearly with an increase in k. Therefore, the proposed method is capable of providing a balance between subset diversity and run-time without sacrificing one for the other.

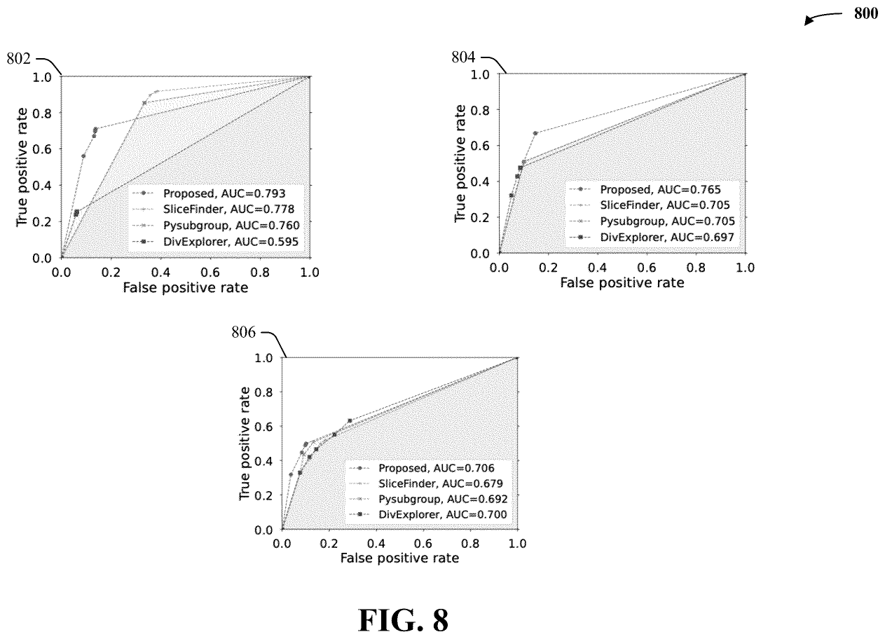

FIG. 8 illustrates an example, non-limiting evaluation of approximating diverse anomalous subset discovery via penalized intersection in accordance with one or more embodiments described herein.

Graph 802, graph 804, and graph 806 depict the AUC of the top-k subsets of the proposed method and other methods of subset discovery on a particular dataset, wherein k=5. The x-axis of graph 802, graph 804, and graph 806 represents the true positive rate, and the y-axis represents the false positive rate. The distance between subsets on the curve implies exploration. Redundant subsets appear closer together, while non-redundant subsets extend the curve, resulting in higher AUC. The gradient of the slope between two points is analogous to the lift from one subset to the other. Therefore, a steeper slope and larger distances between subsets indicates better search space exploration.

Graph 802 illustrates the AUC of the top-k subsets on a first dataset. As shown in graph 802, the proposed method exhibits the highest lift (e.g., steepest slope) for k=1 and the highest AUC among the four subset discovery methods. Graph 804 illustrates the AUC of the top-k subsets on a second dataset. The proposed method exhibits the highest AUC among the tested methods. Graph 806 illustrates the AUC of the top-k subsets on a third dataset. The proposed method achieves the highest lift at k=1. Furthermore, the proposed method exhibits the highest AUC among the tested methods. Overall, the proposed method exhibits the highest average AUC across the three datasets among the tested methods, as previously illustrated by bar graph 702, and outperforms the other subset discovery methods relative to search space exploration.

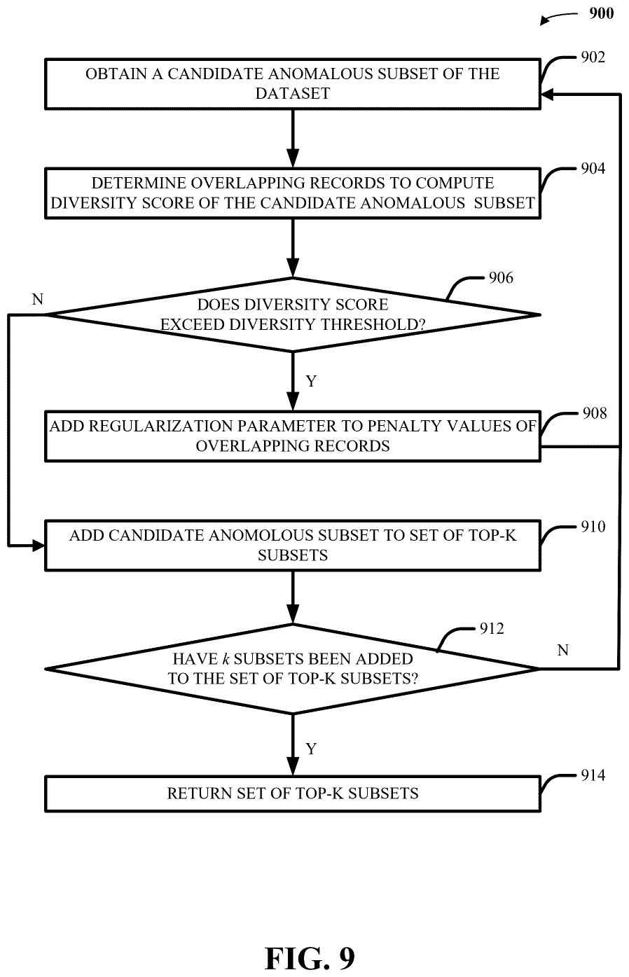

FIG. 9 illustrates a flow diagram of an example, non-limiting method 900 of facilitating diverse anomalous subset discovery via penalized intersection in accordance with one or more embodiments described herein.

At 902, the non-limiting method 900 can comprise obtaining (e.g., by the discovery component 112), by the system, a candidate anomalous subset of the dataset.

At 904, the non-limiting method 900 can comprise determining (e.g., by the scoring component 114), by the system, overlapping records to compute a diversity score of the candidate anomalous subset.

At 906, the non-limiting method 900 can determine if the diversity score exceeds the diversity threshold. If yes (e.g., the diversity score exceeds the diversity threshold), the non-limiting method 900 can proceed to 916. If no (e.g., the diversity score does not exceed the diversity threshold), the non-limiting method 900 can proceed to 906.

At 908, the non-limiting method 900 can comprise adding (e.g., by the regularization component 202), by the system, a regularization parameter to the penalty values of the overlapping records.

At 910, the non-limiting method 900 can comprise adding (e.g., by the selection component 116), by the system, the candidate anomalous subset to the set of top-k subsets.

At 912, the non-limiting method 900 can determine if k subsets have been added to the set of top-k subsets. If yes (e.g., k subsets have been added to the set of top-k subsets), the non-limiting method 900 can proceed to 914. If no (e.g., k subsets have not been added to the set of top-k subsets), the non-limiting method 900 can proceed to 902.

At 914, the non-limiting method 900 can comprise returning (e.g., by the selection component 116), by the system, the set of top-k subsets.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform anomalous subset discovery over a search space as the one or more embodiments described herein can enable this process. And, neither can the human mind nor a human with pen and paper perform automated control for a physical system with generic forecasting models, as conducted by one or more embodiments described herein.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as action trajectory generation code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 12. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a discovery component that obtains a candidate anomalous subset of a dataset;
a scoring component that computes a diversity score of the candidate anomalous subset relative to selected subsets of the dataset; and
a selection component that selects the candidate anomalous subset based on the diversity score.

2. The system of claim 1, wherein the selection component compares the diversity score to a penalty threshold to determine the selected subsets.

3. The system of claim 1, wherein the diversity score is computed with an intersection-over-union measure or intersection-over-previous metric.

4. The system of claim 1, wherein the computer executable components further comprise:
an initialization component that initializes records of the dataset with penalty values.

5. The system of claim 2, wherein the selection component selects the candidate anomalous subset if the diversity score is within the penalty threshold.

6. The system of claim 2, wherein the selection component rejects the candidate anomalous subset if the diversity score is not within the penalty threshold.

7. The system of claim 4, wherein the computer executable components further comprise:
a regularization component that increments the penalty values of records that overlap between the candidate anomalous subset and the selected subsets by a regularization parameter in response to a determination that the candidate anomalous subset is not selected.

8. The system of claim 1, wherein the discovery component selects the candidate anomalous subset based on the penalty values of records in the dataset.

9. The system of claim 7, wherein the regularization component iteratively increments the penalty values, and wherein the discovery component iteratively obtains a candidate anomalous subset of the dataset until the selection component selects the candidate anomalous subset.

10. A computer-implemented method, comprising:
obtaining, by a system operatively coupled to a processor, a candidate anomalous subset of a dataset;
computing, by the system, a diversity score of the candidate anomalous subset relative to selected subsets of the dataset; and
selecting, by the system, the candidate anomalous subset based on the diversity score.

11. The computer-implemented method of claim 10, further comprising:
comparing, by the system, the diversity score to a penalty threshold to determine the selected subsets.

12. The computer-implemented method of claim 10, wherein the diversity score is computed with an intersection-over-union measure or intersection-over-previous metric.

13. The computer-implemented method of claim 10, further comprising:
initializing, by the system, records of the dataset with penalty values.

14. The computer-implemented method of claim 11, further comprising:
selecting, by the system, the candidate anomalous subset if the diversity score is within the penalty threshold.

15. The computer-implemented method of claim 11, further comprising:
rejecting, by the system, the candidate anomalous subset if the diversity score is not within the penalty threshold.

16. The computer-implemented method of claim 13, further comprising:
incrementing, by the system, the penalty values of records that overlap between the candidate anomalous subset and the selected subsets by a regularization parameter in response to a determination that the candidate anomalous subset is not selected.

17. The computer-implemented method of claim 10, further comprising:
selecting, by the system, the candidate anomalous subset based on the penalty values of records in the dataset.

18. The computer-implemented method of claim 16, further comprising:
iteratively incrementing, by the system, the penalty values; and
iteratively obtaining, by the system, a candidate anomalous subset of the dataset until the candidate anomalous subset is selected.

19. A computer program product comprising a non-transitory computer-readable memory having program instructions embodied therewith, the program instructions executable by a processor to cause the processor to:
obtain a candidate anomalous subset of a dataset;
compute a diversity score of the candidate anomalous subset relative to selected subsets of the dataset; and
select the candidate anomalous subset based on the diversity score.

20. The computer program product of claim 19, wherein the program instructions are further executable by the processor to cause the processor to:
compare the diversity score to a penalty threshold to determine the selected subsets.
